(19) United States
(12) Patent Application Publication
(10) Pub. No.: US 2025/0351991 A1
(43) Pub. Date: Nov. 20, 2025

(54) A Water Treatment Apparatus and Method For Coffee Machines

(71) Applicant: Ajeyudu Pathuri, Telangana (IN)

(72) Inventor: Ajeyudu Pathuri, Telangana (IN)

(21) Appl. No.: 19/108,351

(22) PCT Filed: Jun. 13, 2024
(86) PCT No.: PCT/IN2024/050810

§ 371 Date: Mar. 3, 2025

(30) Foreign Application Priority Data
Jul. 21, 2023 (IN) IN202341049251

(51) Int. Cl. A47J 31/46; A47J 31/52; B01D 19/00; C02F 1/20

(52) U.S. Cl. CPC A47J 31/469; A47J 31/461; A47J 31/52; B01D 19/0052; C02F 1/20; C02F 2307/12

(57) ABSTRACT

The present invention relates to an apparatus and method for treating water prior to its use for extraction of coffee in a coffee machine. The coffee machine comprises a water treatment chamber, a first set of one or more pipes. The water treatment chamber for use in a coffee machine comprises a spinning element, a brewing chamber, a second set of one or more pipes and a third set of one or more pipes. The water treatment chamber also comprises one or more fins, one or more sensors and a heating element. The first set of one or more pipes is controlled using a first set of one or more valves. The spinning element is electrically connected and magnetically coupled to the motor. The water treatment chamber receives water through a first set of one or more pipes, spins the received water in the water treatment chamber and extracts the steam and water separately from the water treatment chamber.

### TECHNICAL FIELD

The present invention is directed, in general, towards the treatment of water prior to the extraction of coffee in a coffee machine. The present invention particularly relates to an apparatus and method for treating water prior to its use for extraction of coffee in a coffee machine.

### BACKGROUND

Coffee is an extremely popular drink that is consumed worldwide in different forms. Billions of cups of coffee are enjoyed every year by consumers around the world. Coffee consumption is common among people of all ages and at all times of the day. It is taken at home, at work, in cafes, in coffee shops, in bars and in restaurants.

Coffee generally refers to the liquid comprising various substances found in the coffee bean such as fruit acids, caffeine, lipids, melanoidins, carbohydrates and plant fibre dissolved in water. However, coffee can also refer to different forms of coffee, in different physical states, such as coffee beans, coffee powder, coffee grounds etc.

Coffee, the drink, is sourced from coffee beans. Coffee beans are grinded to form coffee grounds. Coffee grounds are brewed in order to prepare coffee for consumption as a drink. Brewing is a method of preparing coffee, generally from roasted coffee grounds, by passing water or steam through the coffee grounds. However, other materials and steps may also be involved in the process of brewing coffee.

Although coffee beans are generally ground to form coffee grounds before brewing, coffee beans may be brewed directly without grinding.

Coffee beans, coffee powder and coffee grounds are different forms of coffee in the solid state. Coffee beans refer to the seeds of the Coffea plant, which is the original source of coffee. Coffee powder and coffee grounds refer to the finely ground version of coffee beans which is used to prepare coffee beverages.

When preparing coffee beverages, the coffee solubles need to be extracted from the coffee grounds into the water which is used to brew the coffee. This process of extraction of coffee solubles into water is generally referred to as coffee extraction. Coffee solubles refer to substances in coffee beans or coffee grounds that can be dissolved by water or steam. These solubles can include acids (such as malic, citric, acetic, lactic or chlorogenic acids), lipids, fats, melanoidins, caffeine, carbohydrates and coffee bean fibres.

In today's world of coffee, coffee is often prepared using coffee machines of different types and levels of automation. Some of these machines are completely automated i.e. the whole process of preparation of the coffee beverage is automated from start to finish. On the other hand, several coffee machines require human involvement in order to prepare the coffee beverage. These coffee machines that require human involvement in making the coffee beverage, but are partially automated, are called semi-automatic coffee machines.

Cafes, restaurants and coffee shops around the world use automatic and semi-automatic machines to serve coffee beverages to their customers. They also employ baristas, who specialise in preparing different types of coffee beverages using semi-automatic coffee machines. Coffee enthusiasts also purchase semi-automatic coffee machines for preparing customised coffee beverages at home.

Both automatic and semi-automatic coffee machines require water heating components. Coffee machines generally use one or more boilers in order to heat up water to produce hot water and steam, in order to extract the coffee solubles from the coffee grounds and for steaming milk. Some coffee machines may use flow heaters instead of boilers.

Boilers generally work on heat exchange methods. Boilers consist of a heating element and a heat exchanger tube. Water present inside the heat exchanger tube is heated due to heat exchange between the water in the boiler boiled by the heating element, the steam produced thereby, and the heat exchanger tube. However, the water inside the heat exchanger tube, which will subsequently be passed to the place where coffee extraction takes place, is heated unevenly due to several reasons such as the temperature differences between the water and the steam in the boiler.

Currently used boilers in the available machines are unable to maintain a stable temperature of the hot water flowing out of the boiler (generally from the heat exchanger in the boiler). As the boiler starts to heat the water and reach its boiling point, steam is also produced inside the boiler, which leads to a temperature difference at different locations inside the boiler. Therefore, this difference in temperature at different locations inside the boiler affects the temperature of the water that flows out of the heat exchanger and also leads to wastage of energy.

Furthermore, this variation in temperature inside the boiler leads to uneven temperature and pressure at different locations in the water in the heat exchanger, which leads to an inconsistent flow of water, reducing the reliability of the heating process used for coffee extraction. The presence of these variations in temperature of brewing water significantly hampers the desired taste profile in the extracted coffee.

Additionally, in currently available coffee machines, it is also quite difficult for the user to reduce the temperature of water in boilers.

These problems also exist and persist with coffee machines that use flow heaters.

Patent No. US20160353919A1 discloses a “Beverage brewing systems and methods for using the same” which includes a rotating/spinning inlet nozzle through which hot water is introduced to the coffee contained in the coffee cartridge and intermixing takes place. The inlet nozzle may rotate at variable speed in different directions. Furthermore, the inlet nozzle may be moved, rotated, nutated, oscillated, or subjected to any combination of various motions based on the brew cycle duration, type of beverage cartridge, water temperature, or other factors as desired. It discloses the method of introducing water from a rotating inlet nozzle in the brewing chamber for an even mixing of coffee with water. It does not disclose a chamber for treating water inside a coffee machine, prior to the extraction of coffee. It also does not disclose the method and apparatus for treatment and heating of water in an even and efficient manner inside a chamber in the coffee machine, prior to the extraction of coffee.

CN101243945B discloses a “Punching and soaking extractor” in which an extraction cup, eccentric filter bowl and a stirrer are arranged inside the extraction cup body. The Stirrer is rotated by a transmission motor to create a vortex in the brewing liquid injected in the extraction cup. The filter bowl has a container/sheng cup which is placed inside the extraction cup. Tea leaves are positioned inside the sheng cup. When the vortex is created by the stirrer or agitator, the water movement helps in mixing tea in a better way. The spinning of water inside a container to extract tea from tea-leaves is described, which allows for the faster extraction of tea. It uses the method of creating a millet paste to achieve the desirable extraction of either tea or coffee. It does not disclose a chamber for treating water inside a coffee machine, prior to the extraction of coffee.

U.S. Pat. No. 9,307,860B2 discloses a “Processor control of solute extraction system” which relates to a beverage and/or brewing system for rotating, spinning or vertically oscillating an inlet nozzle in the beverage cartridge through which water is introduced in the cartridge to wet and fluidize the beverage medium inside the cartridge to create a brewed beverage. It discloses a method and system including a moving inlet nozzle for use in mixing hot water and coffee in a coffee cartridge. It does not disclose a chamber for treating water inside a coffee machine, prior to the extraction of coffee. It also does not disclose the method and apparatus for treatment and heating of water in an even and efficient manner inside a chamber in the coffee machine, prior to the extraction of coffee.

Therefore, there is a need for a mechanism that can be used to treat the water in coffee machines, prior to use for coffee extraction, in order to provide evenly heated and steadily flowing water for the purposes of extraction of coffee in the coffee machine. This mechanism should also be able to effectively separate the hot water and the steam, in the coffee machine, in order for the water and the steam to be used in a desirable manner i.e. either to extract coffee solubles from the coffee grounds and/or steam the milk respectively. The steam, along with the hot water, may also be used for the extraction of coffee solubles from the coffee grounds.

Such a reliable method and apparatus for treatment and heating of water in an even and efficient manner, which can be implemented in currently used coffee machines (automatic and semi-automatic), with minimal requirement of altering other parameters such as temperature, coffee dose, pressure and grind size, is imperative to achieve a desirable taste profile.

### DISCLOSURE OF THE INVENTION

The principal object of the invention is to provide an improved method and apparatus for treating water in a coffee machine before coffee extraction takes place.

Another object of the invention is to provide a method and apparatus for effectively separating hot water and steam prior to extraction of coffee.

Another object of the invention is to provide a method and apparatus that can be used in a coffee machine to treat water in a manner such that a desirable taste profile can be reliably achieved without altering other parameters such as temperature, coffee dose, pressure and grind size.

Another object of the invention is to provide a method and apparatus for effectively maintaining a stable temperature, thereby reducing the adverse impacts of uneven heating of water, for treating water in the coffee machine prior to coffee extraction.

Another object of the invention is to provide a method of cooling water coming from the boiler or the flow heater.

Another object of the invention is to provide a method to provide steam for certain coffee-based beverages, without having to change the boiler parameters.

### SUMMARY OF THE INVENTION

The following information presents a simplified summary of the disclosure in order to provide a basic understanding for the reader. This summary does not limit the scope of the invention in any way. Its sole purpose is to summarise some of the concepts disclosed herein as a prelude to the more detailed description that is presented later.

In order to overcome the problems described above, especially the problem of undesirable variation and inconsistency in temperature of the hot water used to brew and extract coffee, which leads to uneven and inefficient extraction of coffee solubles into the extracted coffee/espresso (especially in coffee machines), the present invention discloses the use of a method and apparatus to treat water prior to its use for the purposes of coffee extraction. Embodiments of the present invention can be used to stabilise and regulate the temperature and pressure of the hot water flowing out of the boiler, which will subsequently be used to extract coffee from the coffee grounds. The extracted coffee, which is normally espresso but could also include other coffee liquids and beverages, is extracted using different methods of extraction, including the use of valves or controllers, sensors and pipes or tubes.

The present invention can be implemented as part of a coffee brewer, coffee extractor, espresso machine or a coffee machine. Such machines are commonly used to extract coffee or espressos by brewing coffee grounds by passing water or steam through them, generally under pressure. Coffee machine includes reference to automatic coffee machines (which do not require human involvement for preparation of the beverage) as well as semi-automatic coffee machines (which require the involvement of a human, like a barista, for preparation of the beverage after the coffee has been extracted by the machine).

The level of automation in coffee machines is increasing with improving technology, which means that most steps involved in the preparation of the coffee beverage are increasingly being implemented electronically and automatically. Commonly consumed beverages such as cappuccinos and lattes, whether hand-made or machine-made, are prepared from the extracted espresso, by mixing the espresso with other components such as water, milk, and sugar.

In a preferred embodiment of the present invention, a water treatment chamber is provided for the treatment of water, once the water exits the boiler or the flow heater. The water heating component in different coffee machines may be different. For the purposes of describing this invention, the most commonly used component used for heating water in coffee machines has been used i.e. a boiler. However, this invention can be implemented in coffee machines with other systems for heating water as well.

The water that exits the boiler and is eventually used to extract the coffee may come from a heat exchanger present in the boiler or the water may come from the boiler itself. The water treatment chamber, which the water from the boiler enters, uses vortex treatment on the hot water flowing out of the boiler before the water is used for extraction of coffee solubles from the coffee grounds. The vortex treatment is conducted using a propeller or a spinner, hereinafter referred to as a spinning element, that is present inside the water treatment chamber. The spinning element can be rotated inside the water treatment chamber using different methods, such as using an electric motor or by using magnets.

The water treatment chamber may also contain additional features such as fins, in order to improve the temperature consistency of the water received from the boiler. The fins help in creating the cavitation of water inside the water treatment chamber which is useful for the separation of water and steam inside the chamber.

The rotation of the spinning element and the flow of water along the fins inside the water treatment chamber work together to cause cavitation of water to occur. This leads to the formation of low-pressure regions in the water, that lead to the steam rising to the top of the chamber and liquid water settling at the bottom of the chamber.

The water treatment process in the chamber separates the steam and the water while also reducing the inconsistency in the temperature of the water. This chamber, after treating the water received from the boiler, ends up with the water at the bottom and steam at the top. In some cases, the water at the bottom of this chamber may contain a minimal amount of steam.

The water treatment chamber contains multiple inlets and outlets for the flow of water or steam into the chamber and out of the chamber. The hot water in the chamber is used to extract coffee solubles from the coffee grounds. The hot water may also be used to prepare other beverages such as americanos.

It is understood by a person skilled in the art that the hot water extracted from the water treatment chamber may contain a minimal amount of dissolved steam. Furthermore, it is also understood by a person skilled in the art that the steam present at the top of the water treatment chamber may contain a small amount of liquid water.

Features of the water treatment chamber may also be implemented in the boiler itself in order to stabilise and regulate the temperature of water that is subsequently used for coffee extraction.

Embodiments of the present invention may be implemented in fully automatic coffee machines, semi-automatic coffee machines and other coffee machines such as espresso machines and filter coffee machines.

Embodiments of the present invention may be implemented in coffee machines with a single-boiler system and also in coffee machines in a multi-boiler system. They may also be implemented in coffee machines that use different systems to heat water.

The flow of water and steam from the boiler to the water treatment chamber, is controlled automatically (may be controlled by using a CPU/microcontroller) by valves, which account for and measure parameters such as water pressure, water temperature, water flow rate and other required parameters. The components inside the water treatment chamber are also controlled electrically, either using a microcontroller or using a computer/CPU. The control of the components and the flow of water/steam within the coffee machine may depend on real-time information received by the CPU/microcontroller.

Treating the water, which generally includes stabilising the temperature and density of water, before passing it into the brewing chamber would help in extracting coffee solubles more efficiently and evenly. Coffee solubles refer to substances in coffee beans or coffee grounds that can be dissolved by water. These solubles can include acids (such as malic, citric, acetic, lactic or chlorogenic acids), lipids, fats, melanoidins, caffeine, carbohydrates & coffee bean fibres. Such a method and apparatus will facilitate in improving dissolution of the coffee solubles into the water, as per the desired taste profile.

The above-described embodiments are exemplary and outline rather broadly, the features and technical advantages of the present invention, in order that the detailed description of the invention that follows may be better understood. Additional features and advantages of the invention will be described hereinafter which form the subject of the claims of the invention. It should be appreciated by those skilled in the art that the conception and specific embodiments disclosed may be readily utilised as a basis for modifying or designing other structures or processes for carrying out the same purposes of the present invention.

Other aspects of the embodiments of the invention described herein will be better appreciated and understood when considered in conjunction with the following detailed description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof.

### BRIEF DESCRIPTION OF DRAWINGS

FIG. 1 shows the boiler with a heat exchanger in a conventional single-boiler coffee machine.

FIG. 2 shows a preferred embodiment of the present invention as a water treatment chamber.

FIG. 3 shows the implementation of a preferred embodiment of the present invention where the water treatment chamber is implemented in a single boiler (with a heat exchanger) coffee machine.

FIG. 4 shows the implementation of a preferred embodiment of the present invention where the water treatment chamber is implemented in a multi boiler (with a heat exchanger) coffee machine, with the water.

FIG. 5 shows the implementation of a preferred embodiment of the present invention where the water treatment chamber is implemented in a multi boiler (without a heat exchanger) coffee machine, where the water for brewing coffee and steam is delivered to each boiler separately.

FIG. 6 shows the implementation of a preferred embodiment of the present invention where the water treatment chamber is implemented in a single boiler (with a heat exchanger) fully automatic coffee machine.

FIG. 7 shows the implementation of a preferred embodiment of the present invention in a single boiler coffee machine for preparing filter coffee.

FIG. 8 illustrates a flowchart of a method for water treatment in a water treatment chamber for use in a coffee machine, in accordance with the preferred embodiment of the present invention.

### DETAILED DESCRIPTION OF THE INVENTION

The implementation of the embodiments of the present invention is discussed in detail below. It should be understood, however, that the present invention provides a broad scope of inventive concepts that can be embodied in a variety of specific implementations. The specific embodiments discussed herein are merely illustrative of specific ways to implement the invention and do not, in any manner, limit the scope of the invention.

In the following description, numerous specific details are set forth in order to provide a thorough understanding of embodiments of the present invention. It will be apparent to one skilled in the art that embodiments of the present invention may be practised without some of these specific details.

If the specification discloses a component or feature that “may”, “can”, “could”, or “might” be included or have a characteristic, that particular component or feature is not required to be included or have the characteristic.

As used in the description herein and throughout the claims that follow, the meaning of “a”, “an”, and “the” includes plural reference unless the context clearly dictates otherwise. Also, as used in the description herein, the meaning of “in” includes “in” and “on” unless the context clearly dictates otherwise.

Throughout this specification, the use of the words “comprise”, “contain” and “include”, and variations such as “comprises”, “comprising”, “contains”, “containing”, “includes”, and “including” may imply the inclusion of other elements, not specifically recited as well.

Exemplary embodiments will now be described more fully hereafter with reference to the accompanying drawings, in which the exemplary embodiments are shown. This invention may, however, be embodied in many different forms and should not be construed as limited to the embodiments set forth herein. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Numerous modifications, changes, variations, substitutions, and equivalents of the embodiments described herein will be apparent to those skilled in the art, without departing from the spirit and scope of the invention.

There are several types of coffee machines that are used across the globe. Coffee machines have water heating components like boilers which are used to heat up water that is eventually used to extract coffee solubles from the coffee grounds. Some boilers have heat exchangers while other boilers do not. Coffee machines may also use components like flow heaters, in order to heat up water. Embodiments of the present invention can be implemented in any type of coffee machine that has a water heating component, such as a boiler (with or without a heat exchanger) or a flow heater. Embodiments of the present invention have been described using a boiler as it is a commonly used component used to heat up water in coffee machines.

Furthermore, although the embodiments of the present invention described hereinbelow use coffee grounds in order to extract the coffee solubles, the use of coffee pods/coffee capsules as alternatives to coffee grounds is well known in the art and the use of such coffee pods/coffee capsules would be within the scope of the present invention.

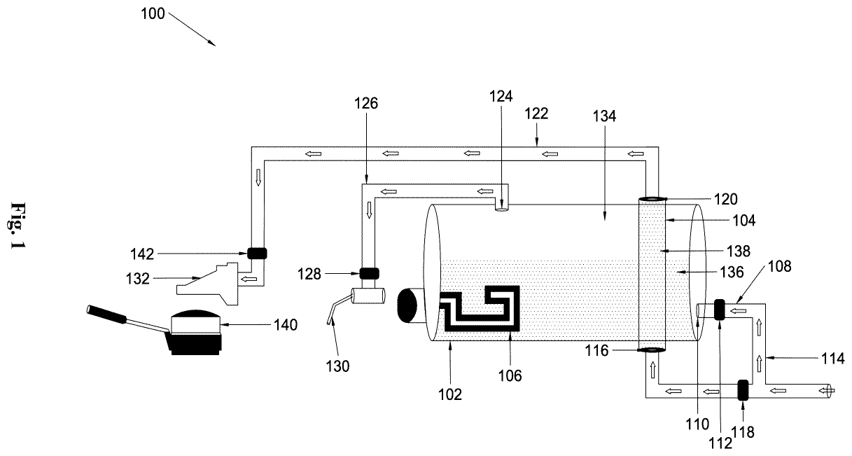

FIG. 1 shows a conventional semi-automatic single-boiler coffee machine 100 that has a boiler 102 with a heat exchanger 104. The boiler 102 receives water from a pipe 108 through a water inlet 110. Flow of water through the water inlet 110 can be controlled using a solenoid valve 112.

The heat exchanger 104 inside the boiler 102 receives water through a pipe 114, which enters the heat exchanger through a water inlet 116. The flow of water through the water inlet 116 for the heat exchanger 104 can be controlled using the solenoid valve 118.

The boiler 102 has a heating element 106 which is used to heat up water 136. This leads to the production of steam 134 inside the boiler 102. The heat exchanger 104 is generally placed inside the boiler 102. Bottom part of the heat exchanger 104 is submerged in the hot water 136 while the top part of the heat exchanger 104 is exposed to the steam 134 inside the boiler 102. The steam 134, being under pressure inside the boiler 102, is at a temperature that is higher than the temperature of the water 136. Therefore, water 138 inside the heat exchanger 104 is exposed to a higher temperature in the top part as compared to the temperature that it is exposed to in the bottom part of the heat exchanger 104.

The steam 134 can be released through an outlet 124 to a steam wand 130, through a pipe 126. Flow of the steam 134 to the steam wand 130 can be controlled using a valve 128. This steam 134 is often used to steam the milk and to create froth in the milk in order to prepare milk-based coffee beverages.

The water 138 in the heat exchanger 104 flows out of an outlet 120 through a pipe 122 to a group head 132. The flow of the water 138 from the heat exchanger 104 to a portafilter 140, which can be locked to the group head, is controlled using a valve 142. The portafilter 140 contains a filter basket that holds coffee grounds through which the water 138 is passed in order to extract coffee solubles.

The difference in temperature of the water 138 leads to the differences in the temperature of the water that is used to extract the coffee solubles in the portafilter 140. This difference in temperatures leads to an undesirable taste profile of the extracted coffee beverage. This also leads to inefficient and uneven extraction of coffee solubles from the coffee grounds.

In order to overcome the drawbacks of conventionally used coffee machines, a water treatment chamber is implemented as an embodiment of the present invention in order to treat the water from a boiler in a coffee machine before it is used to extract coffee solubles from the coffee grounds.

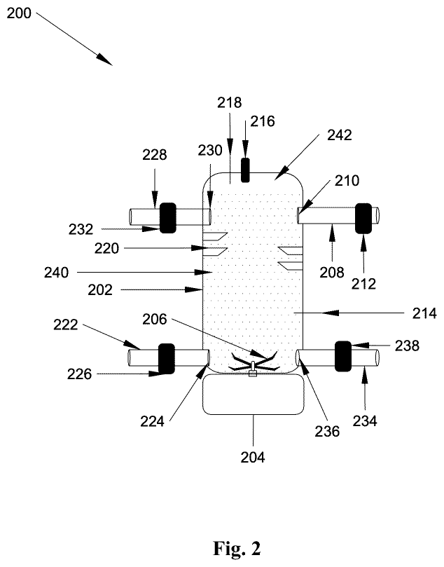

A preferred embodiment of the present invention is implemented as a water treatment chamber 200 as shown in FIG. 2. The water treatment chamber 200 may be implemented in automatic coffee machines as well as semi-automatic coffee machines.

The water treatment chamber 200 has a container 202 which contains several components used to treat water. The chamber 200 has a spinning element 206, which could be a rotor, spinner, stirrer, propeller or any other component, with or without blades attached, that is able to spin. The spinning element 206 is connected to a motor 204 that generates the mechanical movement using electric current, to spin the spinning element 206. The spinning element 206 can be connected to the motor 204 using different techniques, including but not limited to, electrical connection or magnetic coupling. The motor speed may be pre-set or may be controlled by a computer/microcontroller/CPU depending on information received from the chamber 200 using sensors such as the temperature sensor 214 and the water level sensor 218.

The water treatment chamber 200 receives water from the boiler through pipe 208. The flow of water through the water inlet 210 can be controlled using the valve 212.

The water treatment chamber 200 spins the water received from the boiler to remove excess steam from it. The spinning also removes the inconsistency in the water temperature—leading to a more desirable taste profile and temperature of the coffee beverage when the water is used for extraction of coffee solubles.

When the spinning element 206 rotates at the bottom of the water treatment chamber 200, the process of cavitation of water begins. The rotation of the spinning element 206 creates a vortex in the water in the water treatment chamber 200. The vortex creates a centrifugal force in the chamber 200, due to which high density water moves towards the bottom of the chamber 200 and the side walls of the chamber 200. Low density steam moves towards the top of the chamber 200. Centrifugal forces create a low-pressure region at the centre of the vortex. The rotational speed of the water is the highest and the water pressure is the lowest at the bottom of the chamber 200. At the top of the chamber 200, the pressure is highest and the rotational speed of the water is the lowest. Due to the difference in pressure and velocity of the water inside the chamber 200, cavitation occurs in the water. The cavitation leads to the creation of tiny bubbles of steam which are pushed to the top of the chamber.

The spinning of the water causes separation of the water 240 and the steam 242 inside the water treatment chamber 200. Steam 242 is present at the top of the water treatment chamber 200 while the water 240 is present at the bottom of the water treatment chamber 200. In the preferred embodiment of the present invention, the water treatment chamber 200 has additional components such as fins 220 or temperature sensors 214. The fins 220 help in improving the efficiency of separation of steam from the water received from the boiler 102. The sensors 214 and 218 provide important information to a computer/microprocessor that can be used to control the rotational speed of the motor 204 or the valves-in the coffee machine.

It is understood by a person skilled in the art that the water 240, which is extracted from the water treatment chamber 200 may include some amount of steam 242, however this amount is very minimal. Furthermore, it is also understood by a person skilled in the art that the steam 242 present at the top of the water treatment chamber 200 would contain a small amount of liquid water. The reference numbers for water 240 and steam 242 are used for indicative and reference purposes only.

The water 240 is extracted from the water treatment chamber 200, for coffee extraction, through pipe 222. The flow of water through pipe 222 can be controlled using valve 226 present near the water outlet 224. An outlet 230 could also be used to extract water 240 from the water treatment chamber 200.

Any excess water in the water treatment chamber 200 may also be released as waste through outlet 236, feeding pipe 234, controlled using a valve 238.

The steam 242 present at the top of the chamber 200 can be extracted through pipe 228 using valve 232. The steam 242 flows out of the outlet 230. The steam 242 may also be released from the chamber 200 using the valve 216.

In automatic coffee machines, the water treatment chamber 200 is placed between the boiler and the brewing chamber. On the other hand, in semi-automatic coffee machines, the water treatment chamber 200 is placed between the boiler and the group head. The hot water from the boiler, after treatment in the water treatment chamber, is used in the brewing chamber of the automatic coffee machine to extract coffee solubles from the coffee grounds.

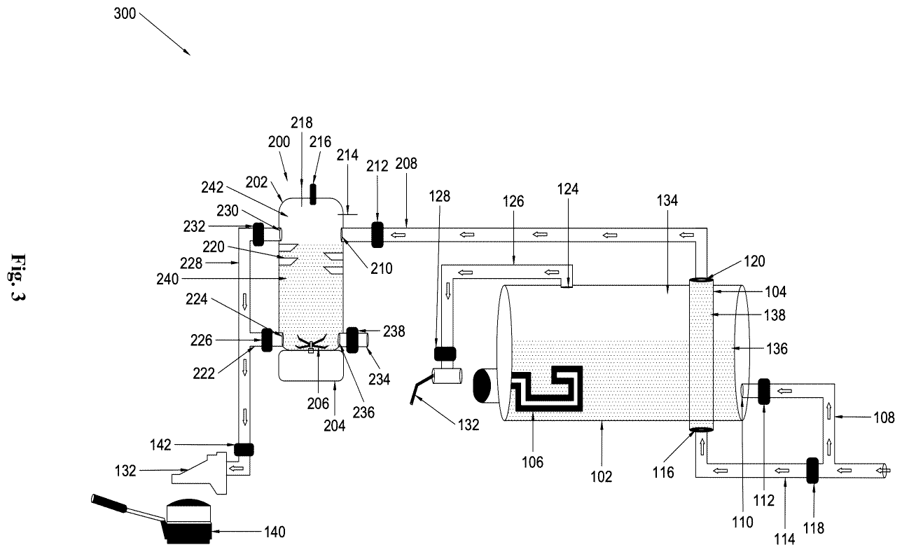

FIG. 3 shows a semi-automatic single boiler coffee machine 300 in accordance with a preferred embodiment of the present invention wherein the water treatment chamber 200 is implemented in the conventional semi-automatic single boiler coffee machine 100. The water treatment chamber 200, as described in FIG. 2, is implemented between outlet 120 of the heat exchanger 104 present in the boiler 102 and the group head 132 of the conventional semi-automatic single boiler coffee machine 100.

The hot water from the heat exchanger 104 in the boiler 102 enters the water treatment chamber 200 through inlet 210 after flowing through pipe 208. The water undergoes treatment as described in FIG. 2 in order to separate the steam 242 and the water 240 in the chamber 200. The water at the bottom of the water treatment chamber 200, with low density of dissolved steam, flows to the group head 132 through outlet 224. Valve 226 is used to control the flow of the water through pipe 222.

The water 240 along with a small amount of steam 242 at the top of the water treatment chamber 200, flows to the group head 132 through outlet 230. Valve 232 is used to control the flow of this water through pipe 228. The flow of the steam 242 through pipe 228 may be controlled using valve 232. The amount of steam 242 and the water 240 that is extracted from the water treatment chamber 200 depends on the desired taste profile and flavour of the beverage.

The treated water 240, that is supplied to the group head 132 through pipes 228 and 222, allows for better extraction of the coffee solubles from the coffee grounds in the portafilter 140, while also providing a more desirable taste profile of the beverage. The portafilter 140 contains a filter basket that holds the coffee grounds through which the treated water 240 is passed through the filter basket to extract the coffee solubles. Furthermore, it is desirable that the extracted beverage has a consistent temperature throughout, in order to improve the drinking experience of the consumer. The consistent temperature can be achieved by the apparatus disclosed herein as the water 240 is treated in the water treatment chamber 200 prior to the preparation of the coffee beverage.

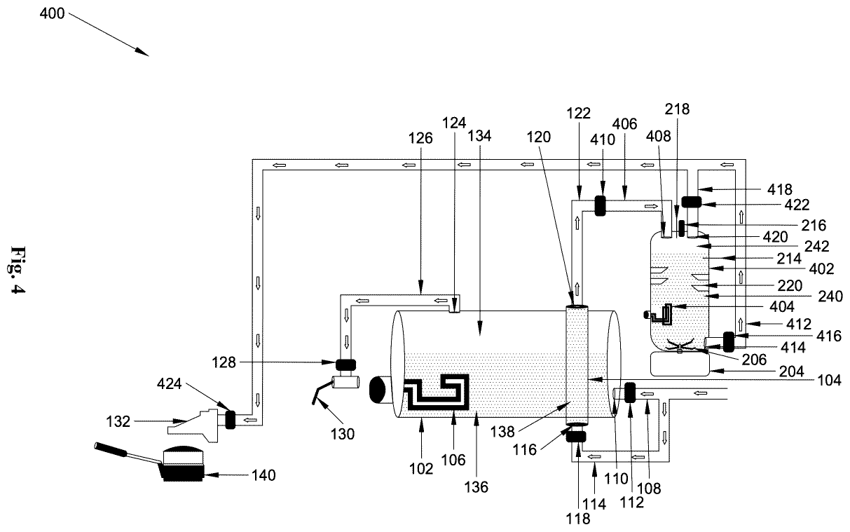

FIGS. 4-7 show the implementation of the preferred embodiment of the present invention in different coffee machine types, with different types of boilers and different levels of automation.

FIG. 4 is an alternative embodiment of the present invention. It shows a semi-automatic coffee machine with a multi-boiler setup 400. It has a two-boiler setup comprising the first boiler 102 and a second boiler 402. In an embodiment, the second boiler 402 includes the features of the water treatment chamber 200 such as the spinning element 206, the motor 204 and the fins 220. The water treatment chamber 200 and the process of treatment of water 138 has been described in FIG. 2. The second boiler 402 receives hot water from the heat exchanger 104 in the first boiler 102 through the water inlet 408, which is connected to the pipe 406. The second boiler 402 has a separate heating element 404 to heat the water, if required by the consumer or barista while preparing the coffee beverage. Valve 410 controls the flow of water from the heat exchanger 104 into the second boiler 402. The water from the heat exchanger 104 is treated in the second boiler 402, which functions like the water treatment chamber 200 described in FIG. 2.

The water at the bottom of the second boiler 402 flows out of the outlet 414 through pipe 412. Valve 416 controls the flow of the water 240 through pipe 412. The steam 242 at the top of the second boiler 402 flows out of the outlet 420 through pipe 418. Valve 422 controls the flow of the water through pipe 418. Additionally, the steam 242 in the second boiler 402 can also be used at the group head 132 as it can flow through the outlet 420 of the second boiler 402. The flow of the steam 242 through pipe 418 can be controlled using valve 422.

The treated water 240 or steam 242, subject to the requirements of the desired taste profile and flavour, are supplied to the group head 132 and the portafilter 140, where the extraction of coffee solubles takes place. The flow of the treated water 240 to the group head 132 can be controlled using valve 424.

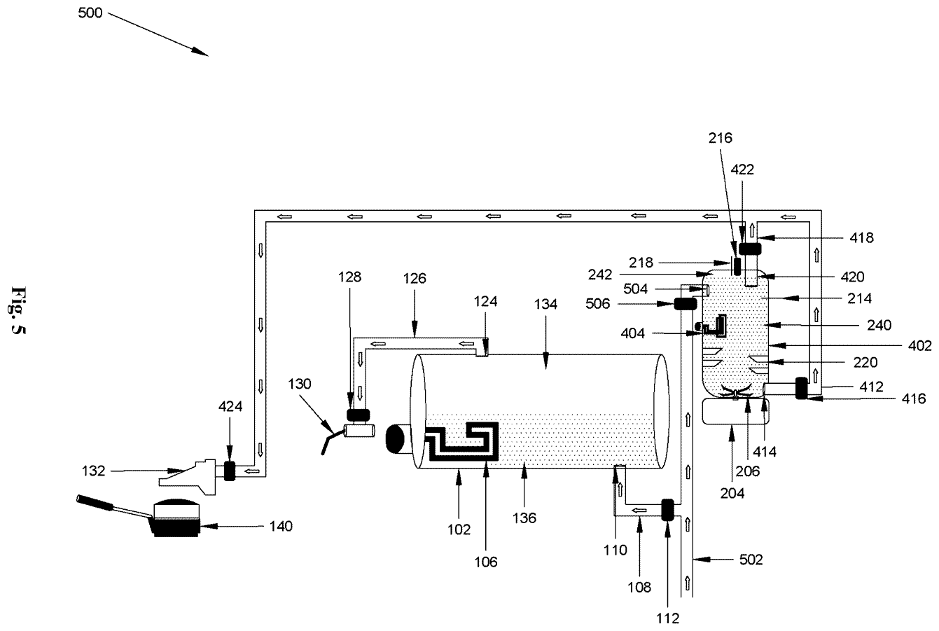

FIG. 5 presents another alternative embodiment of the present invention. It shows a semi-automatic multi-boiler coffee machine without a heat exchanger 500 where the water treatment chamber 200 is implemented as the second boiler 402. The water for brewing coffee is delivered to the first boiler 102 and the second boiler 402 separately. The first boiler 102 does not have the heat exchanger 104 in this particular embodiment. The first boiler 102, which includes the heating element 106, acts as a reservoir of steam 134 for supplying the steam 134 to the steam wand 130.

The steam wand 130 is used to supply steam 134 for steaming the milk. The water flows from the water supply pipe 502 to the second boiler 402 through the water inlet 504. The flow of water to the second boiler 402 through the water inlet 504 can be controlled using the valve 506. In this embodiment, the second boiler 402 includes the features of the water treatment chamber 200 such as the spinning element 206, the motor 204 and the fins 220. The water treatment chamber 200 and the process of treatment of water therein has been described in FIG. 2. The second boiler 402 has a separate heating element 404 to heat the water, if required by the consumer or the barista while preparing the coffee beverage. The water received by the second boiler 402 through inlet 504 is treated in accordance with the principles of the present invention. The flow of water through inlet 504 may be controlled using valve 506.

The water at the bottom of the second boiler 402 flows out of the outlet 414 through pipe 412. Valve 416 controls the flow of the water through pipe 412. The water at the top of the second boiler 402, with high density of dissolved steam, flows out of the outlet 420 through pipe 418. Valve 422 controls the flow of the water through pipe 418. Additionally, the steam 242 in the second boiler 402 can also be used at the group head 132 as it can flow through the outlet 420 of the chamber 200. The flow of the steam 242 through pipe 418 can be controlled using valve 422.

The treated water 240 or steam 242, subject to the requirements of the desired taste profile or flavour, are supplied to the group head 132 and the portafilter 140 where the extraction of coffee solubles take place. The flow of the treated water 240 to the group head 132 can be controlled using valve 424.

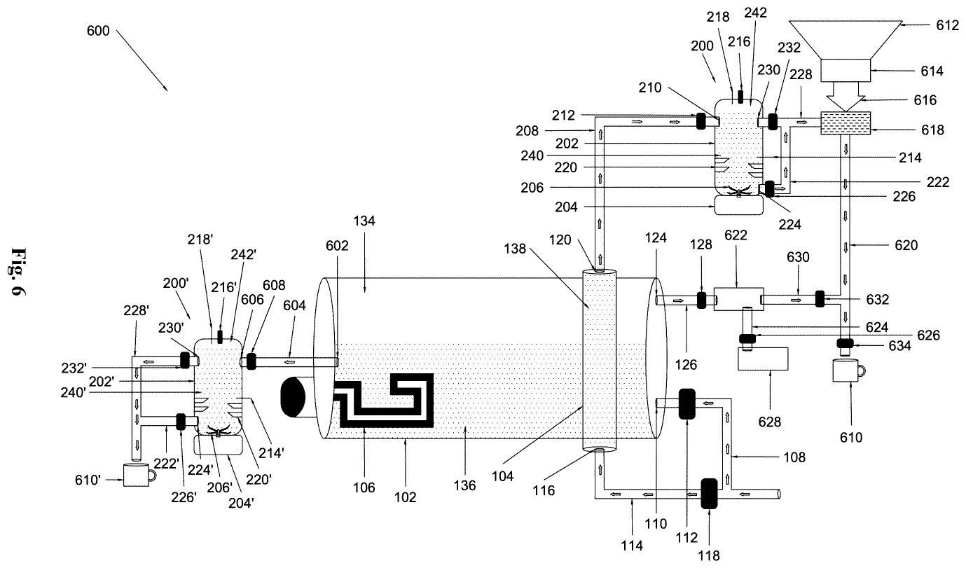

FIG. 6 shows an alternate embodiment of the present invention. A single boiler fully automatic coffee machine 600 with a heat exchanger 104 is shown. The coffee machine 600 is primarily used for the preparation of coffee beverages including but not limited to espressos, cappuccinos and americanos. The coffee machine 600 includes a single boiler 102 which has a heating element 106 for heating the water supplied through water inlet 110. The coffee machine 600 also includes a heat exchanger 104 which is used to heat the water 138 which is subsequently used for the extraction of coffee solubles from the coffee grounds. The hot water 136 inside the boiler 102 is used to heat the water 138 inside the heat exchanger 104. The boiler 102 and the heat exchanger 104 face several problems which affect the quality of the extracted coffee that have already been described in the previous sections. As per the present embodiment of the invention, these problems are overcome in the fully automatic coffee machine 600 by installing the water treatment chamber 200 (described in FIG. 2) between the boiler 102 and the brewing chamber 618.

The water 138 from the heat exchanger 104 is supplied to the water treatment chamber 200 at inlet 210 through pipe 208. The flow of the water 138 to the water treatment chamber 200 may be controlled using valve 212. The water treatment chamber 200 spins the water received from the heat exchanger 104 to separate the steam from the water. The spinning also removes the inconsistency in the water temperature-leading to a more desirable taste profile and temperature of the coffee beverage when this water is used for extraction of coffee solubles from the coffee grounds. The water treatment process is described in detail in FIG. 2. The treated water 240 and the steam 242 are supplied to the brewing chamber 618 through pipes 222 and 228. The flow of the treated water 240 and the steam 242 can be controlled using valves 226 and 232 respectively.

The treated water 240 or steam 242 can be used for the preparation of coffee beverages. To prepare the coffee beverages, coffee beans are added to the container 612. Thereafter, the coffee beans are ground to produce coffee grounds using the grinder 614. The coffee grounds are then supplied to the brewing chamber 618 through the funnel 616. It is understood by a person skilled in the art that coffee machine 600 could be implemented without the container 612 and the grinder 614. In such a case, the coffee grounds are added directly to the funnel 616 which can then be used in the brewing chamber 618, where the coffee solubles are extracted. It is also possible to use coffee pods/capsules instead of coffee grounds or coffee powder. The treated water 240 is passed through the coffee grounds/pods/capsules in order to extract the coffee solubles. The extracted coffee, which contains the extracted coffee solubles, is then poured into the cup 610 through pipe 620. The flow of the extracted coffee to the cup 610 may be controlled using valve 634.

In one embodiment, the coffee machine 600 also includes a milk module 622 for combining steam 134 from the boiler 102, with the milk that is supplied to the milk module 622 from the milk container 628 through pipe 624. The flow of the milk from the milk container 628 to the milk module 622 can be controlled using valve 626. The flow of the steam 134 from the boiler 102 to the milk module 622 through pipe 126 can be controlled using valve 128. The hot milk from the milk module 622 can be added to the extracted coffee, as desired by the user, inside the cup 610 using pipes 630 and 620. The flow of the hot milk to the cup 610 can be controlled using valves 632 and 634. It is understood by a person skilled in the art that the milk module 622, along with the milk container 628 and its supporting components may be implemented outside the coffee machine 600 or they may be implemented in a manner different to what is described in the present embodiment, without departing from the scope of the invention. In this case, the hot milk is prepared separately and can be supplied directly to the cup 610, outside the coffee machine 600.

In another embodiment, the coffee machine 600 can also be used to prepare different types of beverages including but not limited to americano (a type of coffee beverage) or tea. In such a coffee machine 600, a water treatment chamber 200′ is provided between the boiler 102 and the cup 610′. To prepare an americano, hot water 136 from the boiler 102 is supplied to the water treatment chamber 200′ through outlet 602, pipe 604 and inlet 606. The flow of the hot water 136 to the water treatment chamber 200′ can be controlled using valve 608. The water treatment chamber 200′ has a container 202′ which contains several components to treat hot water 136, from the boiler 102, as per the treatment process described in FIG. 2. The chamber 200′ has a spinning element 206′, which could be a rotor, spinner, stirrer, propeller or any other component, with or without blades attached, that is able to spin. The spinning element 206′ is connected to a motor 204′ that generates the mechanical movement using electric current. The motor speed may be pre-set or may be controlled by a computer/microcontroller/CPU depending on information received from the chamber 200′ using sensors such as the temperature sensor 214′ and the water level sensor 218′. The treated water 240′ and steam 242′ are supplied to the cup 610′ through pipes 222′ and 228′ respectively. The flow of the treated water 240′ and the steam 242′ to the cup 610′ can be controlled using valves 232′ and 226′. The steam 242′ may also be released from the chamber 200′ using valve 216′. The flow of water through pipe 222′ can be controlled using the valve 226′ present near a water outlet 224′. Outlet 230′ can also be used to extract water 240′ from the water treatment chamber 200′.

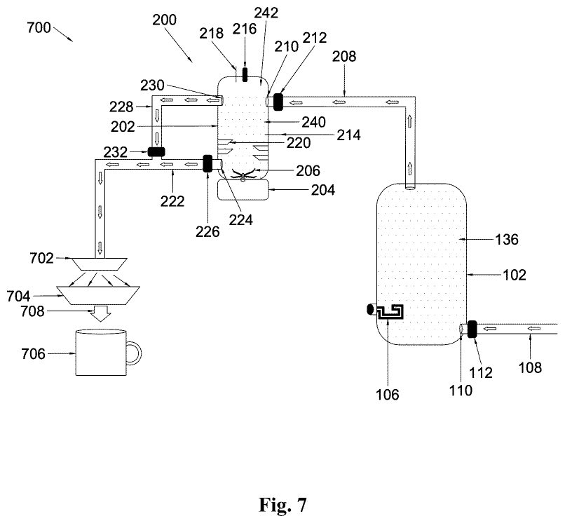

FIG. 7 shows an embodiment of the present invention with an automatic single boiler coffee machine 700 for preparing filter coffee, wherein the water treatment chamber 200 is implemented between the boiler 102 and the shower head 702 of the coffee machine 700. The hot water 136 flows from the boiler 102 to the water treatment chamber 200 through inlet 210 after flowing through pipe 208. The hot water 136 undergoes treatment as described in FIG. 2 in order to separate the steam 242 and the water 240 in the water treatment chamber 200. The water at the bottom of the chamber 200 flows to the shower head 702 through outlet 224. Valve 226 is used to control the flow of this water to the shower head 702 through pipe 222. The steam 242 at the top of the chamber 200 flows to the shower head 702 through outlet 230. Valve 232 is used to control the flow of this steam 242 to the shower head 702 through pipe 228. The flow of the water 240 and steam 242 through pipes 222 and 228 respectively can be controlled using valves 226 and 232. The amount of steam 242 and the water 240 that is extracted from the water treatment chamber 200 depends on the desired taste profile and flavour of the beverage.

The treated water 240, that is supplied to the shower head 702 through pipes 228 and 222, allows for better and consistent extraction of the coffee solubles from the coffee grounds present in the filter basket 704 of the coffee machine 700, while also providing a more desirable taste profile of the beverage. Furthermore, it is desirable that the extracted coffee solubles drip down 708 from the filter basket 704, into the coffee mug 706. This extracted beverage has a consistent temperature throughout, in order to improve the drinking experience of the consumer. It can be used for preparing different types of other coffee beverages including but not limited to filter coffee.

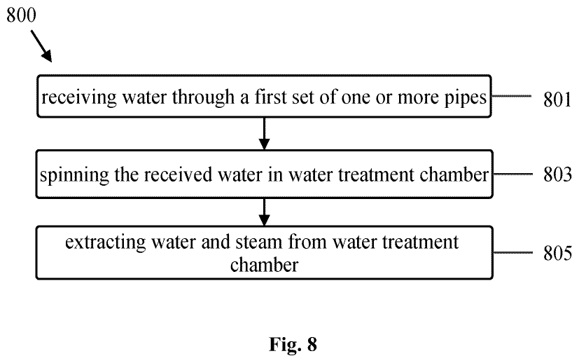

FIG. 8 illustrates a flowchart of method 800, as per the preferred embodiment of the present invention, for water treatment in a water treatment chamber 200 for use in a coffee machine. At step 801, the water treatment chamber 200 receives water from the boiler through pipe 208. At step 803, the water received from the boiler is spun/rotated in the water treatment chamber 200 using the spinning element 206 to separate water and steam. The spinning element 206 may be connected to the motor 204 using different techniques, including but not limited to, electrical connection or magnetic coupling. The motor speed may be pre-set or may be controlled by a computer/microcontroller/CPU depending on information received from the chamber 200 using sensors such as the temperature sensor 214 and the water level sensor 218. At step 805, the separated water and steam are extracted from the water treatment chamber 200. The flow of the water 240 and steam 242 through the pipes 222 and 228 respectively can be controlled using valves 226 and 232.

The present invention can be implemented as per the embodiments described above in order to improve the taste profile of coffee beverages that are consumed using different types of coffee machines and different types of coffee extraction systems with different levels of automation. The above-described embodiments of the present invention are exemplary and non-limiting. They describe specific implementations of the present invention which are not to be construed as limiting the scope of the invention. The present invention can be implemented in different manners and with modifications, which would be obvious to a person skilled in the art, without departing from the spirit and scope of the invention.

1. A coffee machine comprising:
a water treatment chamber, wherein the water treatment chamber comprises a spinning element; and
a first set of one or more pipes to deliver water to the water treatment chamber through one or more inlets;
wherein the spinning element in the water treatment chamber spins to separate water and steam.

2. The coffee machine as claimed in claim 1, wherein the water treatment chamber comprises one or more fins attached to the water treatment chamber.

3. The coffee machine as claimed in claim 1, wherein the water treatment chamber comprises one or more sensors attached to the water treatment chamber.

4. The coffee machine as claimed in claim 1, wherein the spinning element is electrically connected to a motor and a motor speed of the motor is controlled by a computer, a microcontroller or a CPU.

5. The coffee machine as claimed in claim 4, wherein the spinning element is magnetically coupled to the motor.

6. The coffee machine as claimed in claim 1, wherein flow of water through the first set of one or more pipes is controlled using a first set of one or more valves.

7. The coffee machine as claimed in claim 1, wherein the water treatment chamber has a heating element inside the water treatment chamber.

8. The coffee machine as claimed in claim 7, wherein the water treatment chamber comprises:
a second set of one or more pipes to carry water from the water treatment chamber through a first outlet; and
a third set of one or more pipes to carry steam from the water treatment chamber through a second outlet.

9. The coffee machine as claimed in claim 1, wherein the water from the water treatment chamber is used to prepare coffee or tea.

10. A water treatment chamber system for use in a coffee machine comprising:
a boiler;
a water treatment chamber, wherein the water treatment chamber comprises a spinning element;
a brewing chamber;
a first set of one or more pipes to carry water from the water treatment chamber; and
a second set of one or more pipes to carry steam from the water treatment chamber,
wherein the spinning element in the water treatment chamber spins to separate water and steam, and
wherein the brewing chamber receives treated water and steam from the water treatment chamber.

11. The water treatment chamber for use in a coffee machine as claimed in claim 10, wherein the spinning element is electrically connected to a motor and a motor speed of the motor is controlled by a computer, a microcontroller or a CPU.

12. The water treatment chamber for use in a coffee machine as claimed in claim 11, wherein the spinning element is magnetically coupled to the motor.

13. The water treatment chamber for use in a coffee machine as claimed in claim 10, wherein flow of water through the first set of one or more pipes is controlled using a first set of one or more valves.

14. A method for water treatment in a water treatment chamber for use in a coffee machine, the method comprising:
receiving water through a first set of one or more pipes;
spinning the received water in the water treatment chamber using a spinning element to separate water and steam; and
extracting the water and the steam separately from the water treatment chamber.

15. The method as claimed in claim 14, wherein flow of extracted water through the first set of one or more pipes is controlled using a first set of one or more valves.

16. The method as claimed in claim 14, wherein the extracted water and the extracted steam are merged into a merged pipe, and wherein a processor, a microcontroller or computer controls flow of the extracted water and the extracted steam into the merged pipe.

17. The method as claimed in claim 14, wherein the spinning element is electrically connected to a motor and a motor speed of the motor is controlled by a computer, a microcontroller or a CPU.

18. The method as claimed in claim 17, wherein the spinning element is magnetically coupled to the motor.

19. The method as claimed in claim 14, wherein the water treatment chamber has a heating element inside the water treatment chamber.

20. The method as claimed in claim 19, wherein the water treatment chamber comprises:
a second set of one or more pipes to carry water from the water treatment chamber through a first outlet; and
a third set of one or more pipes to carry steam from the water treatment chamber through a second outlet.
